(19) United States
(12) Patent Application Publication
(10) Pub. No.: US 2005/0208229 A1
(43) Pub. Date: Sep. 22, 2005

(54) Process for producing adhesive film

(75) Inventors: Hironobu Iyama, Tsukuba-shi (JP); Toru Fujiki, Tsukuba-shi (JP)

Correspondence Address: BIRCH STEWART KOLASCH & BIRCH, PO BOX 747, FALLS CHURCH, VA, 22040-0747, US

(73) Assignee: Sumitomo Chemical Company, Limited, Tokyo (JP)

(21) Appl. No.: 11/006,668

(22) Filed: Dec. 8, 2004

(30) Foreign Application Priority Data
Dec. 11, 2003 (JP) 2003-412960

(51) Int. Cl. B32B 9/04

(52) U.S. Cl. 427/496; 428/411.1

(57) ABSTRACT

An adhesive film is produced by irradiating electron beam to a film made of an electron beam-curable resin, the adhesive film having a flowability with little dispersion thereof at melt-adhesion. The production process comprises two or more steps of irradiating electron beam to a film made of an electron beam-curable resin, wherein a standard deviation and a dispersion degree of the accumulated irradiation doses irradiated on partitions of the adhesive film after the final irradiation step, are respectively smaller than those after the last irradiation step before the final irradiation step, wherein the dispersion degree is a value obtained by dividing the difference in the accumulated irradiation dose between its maximum and minimum doses by its average does.

### BACKGROUND OF THE INVENTION

1. Field of the Invention

The present invention relates to a process for producing an adhesive film.

2. Description of the Related Art

Since an adhesive film exhibiting adhesive property in heat-melting is easily handled, its use has been recently expanded as an adhesive in electric and electronics fields. As a process for producing the adhesive film, a method of irradiating electron beam to a polyethylene-based copolymer having an epoxy group in its molecule has been known (JP-A-2000-144082).

However, the adhesive film obtained by such a production process has a flowability varying widely (i.e., an unequable flowability) at melt-adhesion. As a result, the adhesive film is insufficient in performance such that adequate adhesive strength can not be achieved and a portion of a molten resin of which the film is made, is protruded from an adhesive face.

### SUMMARY OF THE INVENTION

One of the objects of the present invention is to provide a process for producing an adhesive film having a flowability with little dispersion (variation) thereof (i.e., an equable flowability thereof) at melt-adhesion.

The present inventors have found out that when an adhesive film is produced by irradiating electron beam to a film made of an electron beam-curable resin, the adhesive film having a flowability with little dispersion thereof at melt-adhesion can be obtained by adjusting a standard deviation and a dispersion of the irradiation dose of electron beam per unit area of the electron beam-curable resin film. Based on the above findings, the present invention has been accomplished.

The present invention provides a process for producing an adhesive film comprising two or more steps of irradiating electron beam to a film made of an electron beam-curable resin, wherein
a standard deviation and a dispersion degree, of the accumulated irradiation doses of electron beam irradiated on partitions of the adhesive film equally partitioned into the same area and the same shape as one another after the final irradiation step
   are respectively smaller than
a standard deviation and a dispersion degree, of the accumulated irradiation doses of electron beam irradiated on partitions of the resin film equally partitioned into the same area and the same shape as one another after the last irradiation step before the final irradiation step,
   wherein the dispersion degree of the accumulated irradiation doses of electron beam is a value which is obtained by dividing the difference in the accumulated irradiation dose between its maximum dose and its minimum dose by its average dose.

Further, the present invention provides the above-mentioned adhesive film; a laminate film comprising the adhesive film and a support; a laminate obtained by placing the adhesive film on an article and thermally curing the film; and a semiconductor part containing the laminate.

In accordance with the process for producing an adhesive film in the present invention, an adhesive film having a flowability with little dispersion thereof when melted.

### BRIEF DESCRIPTION OF DRAWINGS

FIG. 1(a) and FIG. 1(b) show a device which can be used for electron beam irradiation in the present invention.

### DESCRIPTION OF PREFERRED EMBODIMENTS

A process for producing an adhesive film comprises a step of irradiating electron beam to a film made of a resin having a curable property with electron beam.

More specifically, the production step in the present invention comprises two or more steps in which electron beam is irradiated in each step to a film made of a resin having a curable property with electron beam. Namely, electron beam is irradiated to the resin film twice or more times.

Here, the irradiation of electron beam twice or more times means that after the electron beam is irradiated on the resin film, the electron beam is further irradiated to the resin film once or more times.

In the present invention, the electron beam is irradiated to the above-described electron beam-curable film so that
a standard deviation and a dispersion (variation) degree, of the accumulated irradiation doses of electron beam irradiated per unit area (i.e., the area of respective partitions of the finally obtained film (or an adhesive film) equally partitioned into the same area and the same shape as one another) after the final irradiation step
   are respectively smaller than
a standard deviation and a dispersion degree, of the accumulated irradiation doses of electron beam irradiated on partitions of the resin film equally partitioned into the same area and the same shape as one another after the last irradiation step just before the final irradiation step.

Here, the dispersion degree of the accumulated irradiation dose of electron beam means a value which is obtained by dividing the difference in the accumulated irradiation dose between the maximum dose and the minimum dose by its average dose.

Preferably, when the number of steps of irradiating the electron beam to the resin film is set as “n” (wherein “n” represents an integer of 2 or more), the electron beam is irradiated to the electron beam-curable film so that
a standard deviation and a dispersion degree, of the accumulated irradiation doses of electron beam irradiated on partitions of the resin (or adhesive) film equally partitioned into the same area and the same shape as one another after the n^{th} irradiation step
   are respectively smaller than
a standard deviation and a dispersion degree, of the accumulated irradiation doses of electron beam irradiated on partitions of the resin film equally partitioned into the same area and the same shape as one another after the (n−1)^{th} irradiation step.

In order to control the standard deviation and dispersion degree of the accumulated irradiation dose of electron beam after the final irradiation step (or the n^{th} irradiation step) to be smaller than those of the accumulated irradiation dose of electron beam after the step immediately before the final irradiation step (or the n−1^{th} irradiation step), the electron beam is irradiated so that the accumulated irradiation dose of electron beam per unit area (i.e., onto each partition of the resin (or adhesive) film equally partitioned into the same area and the same shape as one another) after the final irradiation step (or the n^{th} irradiation step) is as uniform as possible.

The dose of electron beam irradiated to the film can be determined, for example, by the following methods.

For example, an irradiation dose of electron beam which has been irradiated and actually has been reached onto each partition of a film equally partitioned into the same area and the same shape as one another, from the electron beam-generating source in a electron beam irradiating device, can be measured by the method described in “Chemical Handbook, Application Edition” page 1228 (Maruzen Co., Ltd., published in 1965). Specifically,
1) The γ-rays of radioactive cobalt (of which electron beam-irradiation doses have previously been known) are respectively irradiated onto sample films (in which a dye has been dispersed) for an operation time (“t” hour(s)), to prepare standard electron-beam-irradiated films, each film of which has a different hue depending on the different irradiation dose of the electron beam;
2) Using the standard films, a calibration line showing relation between the irradiation dose of electron beam irradiated for t hour(s) and the hue of the irradiated film is obtained;
3) A plural number of other sample films for measurement (in which the same dye as used above has been dispersed) are placed onto the surface on which electron beam irradiation is to be conducted for t hour(s) by a electron-beam irradiation-device for producing an adhesive film, one by one at each of the positions corresponding to the above-mentioned partitions of the adhesive film;
4) Electron beams are irradiated onto the electron-beam-irradiating surface for t hours; and
5) Each of the irradiation doses of electron beams irradiated to respective partitions after electron beam irradiation for t hours can be determined based on the hues of sample films for measurement, using the previously prepared calibration line.

When an electron beam irradiation at a certain irradiation step is conducted fort hour(s), the irradiation dose of electron beam irradiated on the respective partitions of a film at the step is determined by the above-mentioned method. The accumulated irradiation dose of electron beam irradiated on the respective partitions of the film obtained after the n^{th} irradiation step corresponds to the total of the irradiation doses of electron beams irradiated in the respective steps.

By the following simulation, it can be determined how many irradiation steps are preferably carried out using a certain electron-beam-irradiating device in the present invention.

For example, it is assumed that an irradiation operation for t hour(s) in total is conducted by dividing the operation into several steps (repeatedly carried out in turn, while the irradiation location of the film is optionally changed), then the accumulated irradiation doses (of electron beams irradiated on each partition equally partitioned into the same area and the same shape) obtained after the n−1^{th} irradiation step and the n^{th} irradiation step are respectively simulated under such an assumption. Based on the result of the simulation, can be determined a number “n” of steps in which (i) a standard deviation and a dispersion degree, of the accumulated irradiation doses of electron beam irradiated on partitions of the film equally partitioned into the same area and the same shape obtained after the n^{th} step, are respectively smaller than (ii) a standard deviation and a dispersion degree after the (n−1)^{th} step. The n^{th} step thus determined can be made as the final step in a preferable embodiment of the present invention, and therefore, an appropriate final irradiation step (namely, the number of irradiation steps) in the present invention can be determined using the electron-beam-irradiation device.

The standard deviation of the accumulated irradiation doses of electron beam irradiated on partitions of the film obtained after the final step is preferably in the range of 0 to 5, more preferably in the range of 0 to 4 and most preferably in the range of 0 to 3.5.

The dispersion degree of the accumulated irradiation doses of electron beam irradiated on partitions of the adhesive film obtained after the final step is preferably in the range of 0 to 0.1, more preferably in the range of 0 to 0.08 and most preferably in the range of 0 to 0.06.

Although not outside the scope of the present invention, when the above-mentioned standard deviation exceeds 5 and/or the above-mentioned dispersion degree exceeds 0.1, the flowability at melt-adhesion of the resulting adhesive film tends to be hardly stable.

The accumulated irradiation doses of electron beam irradiated on each partition of the adhesive film obtained after the final step may be, on an average, in the range of about 10 to 300 kGy, preferably in the range of about 10 to 200 kGy, and most preferably in the range of about 50 to 250 kGy. Although not outside the scope of the present invention, when the average of the irradiated doses is less than 10 kGy, a molten resin of the adhesive film tends to easily protrude from the intended adhesion face at melt-adhesion, and also when it exceeds 300 kGy, adhesion property of the adhesive film tends to be insufficient.

The electron beam irradiation device (apparatus), which can be used in the present invention, comprises:
a means of irradiating electron beam (preferably in a continuous manner) to a film made of an electron beam-curable resin;
a means of delivering the film to the irradiating position of electron beam;
a means of winding and collecting the film after being irradiated with electron beam; and
an optional means of delivering again the film wound and collected (preferably in a continuous manner), to the irradiating position of electron beam. When such a device is utilized, and electron beam is irradiated to an electron beam-curable resin twice or more times, then the film obtained after the irradiation of electron beam is wound and collected, and the collected film can be continuously delivered again to the irradiating position of electron beam. Therefore, electron beam irradiation can be easily conducted, which is preferred.

Further, when electron beam is irradiated to the film made of a resin having a curable property with electron beam, the electron beam is preferably irradiated in the presence of nitrogen. This is because oxygen tends to inhibit crosslinking reaction for curing of the resin, and the presence of nitrogen can prevent such an inhibition due to oxygen.

The electron beam irradiation device, which can be used in the present invention, may be a low energy-type device in which an acceleration voltage for accelerating electron beam is in the range of about 10 to 300 kV, or may be a middle energy-type device in which the acceleration voltage is in the range of about 300 to 5,000 kV, or may be a high energy-type device in which the acceleration voltage is in the range of about 5,000 to 10,000 kV. The low energy-type device is preferably utilized in the present invention from the viewpoint of easy operation.

In the present invention, the irradiation of electron beam may be conducted with a voltage for accelerating the electron beam in the range of 100 to 250 kV. Preferably, it is appropriately set depending on the thickness of a film to be treated with the irradiation. For example, when the thickness of the film is 100 μm, the acceleration voltage is preferably in the range of 200 to 250 kV.

A method for accelerating electron using the above-described device is not specifically limited. Examples of the method include a linear cathode process, a module cathode process, a thin plate cathode process, a low energy scanning process and the like. In the method, an electron beam irradiation device manufactured by Iwasaki Electric Co., Ltd., a device manufactured by ESI (electro scientific industries), U.S.A. and the like can be utilized.

In the present invention, the resin having a curable property in irradiation of electron beam, is utilized.

Examples of such a resin include:
a resin comprising (A) an olefin-based copolymer,
a resin comprising (A) an olefin-based copolymer and (B) a curing agent,
a resin comprising (A) an olefin-based copolymer, (B) a curing agent and (C) a curing catalyst, and the like.

Examples of the olefin-based copolymer (A) includes a polyethylene, an ethylene-acid anhydride copolymer, an ethylene-(meth)acrylic acid ester copolymer, a poly(meth)acrylic acid ester, a (meth)acrylic acid ester copolymer, a polystyrene, a styrene-butadiene-styrene block copolymer, a hydrogenated product of styrene-butadiene-styrene block copolymer, a partially hydrogenated product of styrene-butadiene-styrene block copolymer, an epoxy modified product of the partially hydrogenated product of styrene-butadiene-styrene block copolymer, a styrene-isoprene-styrene block copolymer, a hydrogenated product of styrene-isoprene-styrene block copolymer, a partially hydrogenated product of styrene-isoprene-styrene block copolymer, an epoxy modified product of the partially hydrogenated product of styrene-isoprene-styrene block copolymer, an ethylene-based copolymer containing an epoxy group, an amorphous modified polyester and the like.

Among these, preferable examples of the olefin-based copolymer (A) include an ethylene-acid anhydride copolymer, an ethylene-(meth)acrylic acid ester copolymer, a poly(meth)acrylic acid ester, a (meth)acrylic acid ester copolymer, a styrene-butadiene-styrene block copolymer, and an ethylene-based copolymer containing an epoxy group, and more preferably an ethylene-based copolymer containing an epoxy group.

Two or more of the olefin-based copolymers (A) may be used together, if needed, in the present invention.

Examples of the above-mentioned ethylene-based copolymer containing an epoxy group includes a copolymer containing, as the structural units thereof, the groups respectively derived from
(a1) ethylene and
(a2) a monomer represented by formula (1) 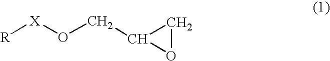
   wherein R represents a hydrocarbon group having 2 to 18 carbon atoms which has one or more of double bonds, and a hydrogen atom in the hydrocarbon group is optionally substituted with a halogen atom, a hydroxy group or a carboxyl group; and X represents a single bond or a carbonyl group.

Examples of R in formula (1) include the groups of formulae (2) to (8) below:

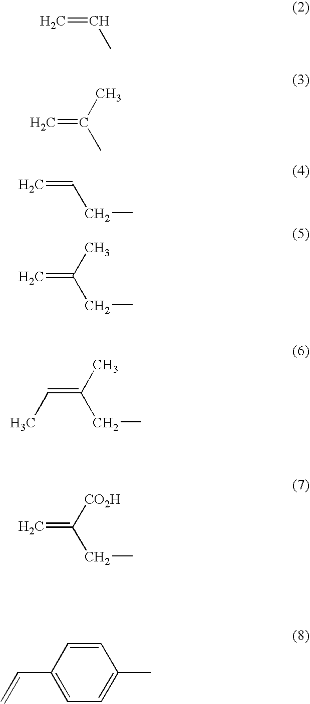

Examples of monomer (a2) includes unsaturated glycidyl ethers such as allyl glycidyl ether, 2-methylallyl glycidyl ether and styrene-p-glycidyl ether; unsaturated glycidyl esters such as glycidyl acrylate, glycidyl methacrylate and glycidyl itaconate, and the like.

The amount of the structural unit derived from monomer (a2) is preferably in the range of about 1 to 30 parts by weight based on 100 parts by weight of the ethylene-based copolymer (containing ethylene (a1) and the monomer (a2) as structural units). When the structural unit derived from monomer (a2) is 1 part by weight or more, the adhesion property of the resulting adhesive film tends to be improved, which is preferred. Further the structural unit derived from monomer (a2) is 30 parts by weight or less, mechanical strength of the adhesive film tends to be improved, which is also preferred.

Further, the amount of the structural unit derived from ethylene (a1) is preferably in the range of about 30 to 99 parts by weight, and is more preferably in the range of about 70 to 99 parts by weight, based on 100 parts by weight of the ethylene-based copolymer.

In addition to ethylene (a1) and monomer (a2), the above-mentioned ethylene-based copolymer containing an epoxy group can further contains, as the structural unit thereof, a group derived from monomer (a3) having a functional group copolymerizable with ethylene and being different from ethylene (a1) and monomer (a2).

Examples of monomer (a3) includes α,β-unsaturated carboxylic acid alkyl esters containing alkyl group having 3 to 8 carbon atoms such as methyl acrylate, ethyl acrylate, n-propyl acrylate, isopropyl acrylate, n-butyl acrylate, t-butyl acrylate, isobutyl acrylate, methyl methacrylate, ethyl methacrylate, n-propyl methacrylate, isopropyl methacrylate, n-butyl methacrylate, t-butyl methacrylate and isobutyl methacrylate; vinyl esters having carboxylic acid having 2 to 8 carbon atoms such as vinyl acetate, vinyl butyrate, vinyl propionate, vinyl pivalate, vinyl laurate, vinyl isononanate and vinyl versatate; α-olefins having 3 to 20 carbon atoms such as propylene, 1-butene and isobutene; dienes such as butadiene, isoprene and cyclopentadiene; vinyl compounds such as vinyl chloride, styrene, acrylonitrile, methacrylonitrile, acryl amide and methacryl amide, and the like.

Among these, preferable examples of monomer (a3) include propylene, vinyl acetate, methyl acrylate, ethyl acrylate, n-butyl acrylate and methyl methacrylate.

The amount of the structural unit derived from monomer (a3) in the ethylene-based copolymer containing an epoxy group may be in the range of about 0 to 70 parts by weight, and is preferably in the range of 5 to 60 parts by weight, based on 100 parts by weight of the ethylene-based copolymer containing an epoxy group. When the amount of the structural unit derived from monomer (a3) in the ethylene-based copolymer containing an epoxy group is 70 part by weight or less, the ethylene-based copolymer tends to be easily produced by a high pressure radical process and the like, and therefore, is preferred.

The ethylene-based copolymer containing an epoxy group, which can be utilized in the present invention, may be any of a block copolymer, a graft copolymer, a random copolymer and an alternate copolymer. Among these, a random copolymer and a graft copolymer are preferred, and further, a graft copolymer is most preferred. Examples of the graft copolymer includes a copolymer obtained by graft-polymerizing monomer (a2) with a propylene-ethylene block copolymer (see, Japanese Patent No. 2632980); a copolymer obtained by graft-polymerizing an α,β-unsaturated carboxylic acid eater with a copolymer of ethylene and an epoxy-group-containing monomer (see, Japanese Patent No. 2600248); and the like.

Examples of the production process of the ethylene-based epoxy-group-containing copolymer, which can be used in the present invention, includes a process of copolymerizing monomer (a2) (or monomer (a2) and monomer (a3)) with ethylene (a1) in the presence of a radical-generating agent under a pressure of 500 to 4,000 atm at a temperature of 100 to 300° C. in the presence or absence of an appropriate solvent and a chain transfering agent; a process of melt-graft-copolymerizing monomer (a2) (or monomer (a2) and monomer (a3)) with a polyethylene-based resin in the presence of a radical-generating agent in an extruder.

Examples of the polyethylene-based resin include a homopolymer of ethylene (a1), a copolymer comprising ethylene (a1) and monomer (a3), and the like.

The ethylene-based copolymer containing an epoxy group preferably has an MFR (melt flow rate; measured using a load of 2.16 kg at a temperature of 190° C.) in the range of about 1 to 1,000 g/10 min, and more preferably has an MFR in the range of about 1 to 500 g/10 min. The MFR can be measured in accordance with JIS K7210. When the ethylene-based copolymer with MFR of 1 g/10 minor more, flowability of the resulting resin in melting is improved, and therefore, the resulting adhesive film is easily processed, which is preferred. Further, when the ethylene-based copolymer with MFR of 500 g/10 min or less, melt tension of the resin is improved, and therefore, the resulting adhesive film easily processed, which is preferred.

The ethylene-based copolymer containing an epoxy group may be, for example, commercially available products such as “Bond Fast (trade name)” Series (manufactured by Sumitomo Chemical Co., Ltd.), “Sepolsion G (trade name)” Series (manufactured by Sumitomo Fine Chemical Co., Ltd.) and “Rexpearl RA (trade name)” Series (manufactured by Japan Polyolefin Co., Ltd.).

As described above, the resin having a curable property with electron beam, which is used in the present invention, may be a resin comprising (A) an olefin-based copolymer and (B) a curing agent.

Examples of curing agent (B) include phenol-novolak resins, polyvalent carboxylic acids, polyvalent carboxylic anhydride, ester group-containing acid anhydrides, amine compounds and the like.

Examples of the phenol-novolak resins includes a phenol-formaldehyde polycondensation product, an alkylphenol-formaldehyde polycondensation product, a bisphenol A-formaldehyde polycondensation product, a phenol-modified dicyclopentadiene, a phenol-modified liquid polybutadiene, a phenol-modified terpene resin and the like.

Examples of the polyvalent carboxylic acids include an aliphatic polyvalent carboxylic acid, an aromatic polyvalent carboxylic anhydride and the like.

Specific examples of the polyvalent carboxylic acids include aliphatic polyvalent carboxylic acids such as succinic acid, adipic acid, azelaic acid, sebacic acid, dodecane dicarboxylic acid, itaconic acid, maleic acid, citraconic acid, tetrahydrophthalic acid, hexahydrophthalic acid, methyltetrahydrophthalic acid, cyclopentane tetracarboxylic acid and 1,2,3,4-butanetetracarboxylic acid; aromatic polyvalent carboxylic acids such as phthalic acid, terephthalic acid, isophthalic acid, trimellitic acid, pyromellitic acid and benzophenone tetracarboxylic acid; and the like.

Examples of the polyvalent carboxylic anhydride include an aliphatic polyvalent carboxylic anhydride, an aromatic polyvalent carboxylic anhydride and the like.

Specific examples of the polyvalent carboxylic anhydride include aliphatic polyvalent carboxylic anhydrides such as itaconic anhydride, maleic anhydride, citraconic anhydride, dodecenylsuccinic anhydride, tetrahydrophthalic anhydride, hexahydrophthalic anhydride, methyltetrahydrophthalic anhydride, mathylhexahydrophthalic anhydride, endomethylenetetrahydrophthalic anhydride, methylendomethylenetetrahydrophthalic anhydride, cyclopentane tetracarboxylic anhydride and 1,2,3,4-butanetetracarboxylic di-anhydride; aromatic polyvalent carboxylic anhydrides such as phthalic anhydride, trimellitic anhydride, pyromellitic anhydride, benzophenone tetracarboxylic anhydride and 3,3′,4,4′-diphenylsulfone tetracarboxylic di-anhydride, etc.

Examples of the eater-group-containing acid anhydrides include an ethylene glycol bistrimellitate, a glycerin tristrimellitate and the like.

Examples of the amine compounds include an amine such as dicyandiamide, diaminophenylmethane, diaminodiphenylsulfone and the like.

Further, as described above, the resin having a curable property with electron beam, which can be used in the present invention, may be a resin comprising (A) an olefin-based copolymer, (B) a curing agent and (C) a curing catalyst.

Examples of the curing catalyst (C) include tertiary amines, quaternary ammonium salts, imidazoles, organic phosphorous compounds, sufonium salts and the like.

Examples of the tertiary amines include triethylamine, tributylamine, 1,8-diazabicyclo[5,4,0]-7-undecene (hereinafter, referred to as DBU), 1,5-diazabicyclo[4,3,0]-5-nonene (hereinafter, referred to as DBN).

Examples of the quaternary ammonium salt include quaternary ammonium salts such as a phenol salt of DBU, an octylic acid salt of DBU, a p-toluene sulfonic acid salt of DBU, a formic acid salt of DBU, a phthalic acid salt of DBU, a phenol-novolak resin salt of DBU, a phenol-novolak resin salt of DBN, a tetraphenyl borate salt of DBU, and the like.

Examples of the imidazoles include 2-ethylimidazole, 2-undecylimidazole, 2-heptadecylimidazole, 2-ethyl-4-methylimidazole, 2-phenylimidazole, 2-phenyl-4-methylimidazole, 1-benzyl-2-methylimidazole, 1-benzyl-2-phenylimidazole, 1-cyanoethyl-2-methylimidazole, 1-cyanoethyl-2-ethyl-4-methylimidazole, 1-cyanoethyl-2-undecylimidazole, 1-cyanoethyl-2-phenylimidazole, 1-cyanoethyl-2-undecylimidazolium trimellitate, 1-cyanoethyl-2-phenylimidazolium trimellitate, 2,4-diamino-6-[2′-methylimidazolyl-(1′)]-ethyl-s-triazine, 2,4-diamino-6-[2′-undecylimidazolyl-(1′)]-ethyl-s-triazine, 2,4-diamino-6-[2′-ethyl-4′-methylimidazolyl-(1′)]-ethyl-s-triazine, 2,4-diamino-6-[2′-methylimidazolyl-(1′)]-ethyl-s-triazine isocyanuric acid adduct, 2-phenylimidazole isocyanuric acid adduct, imidazole, 2-methylimidazole isocyanuric acid adduct, 2-phenyl-4,5-dihydroxymethylimidazole, 2-phenyl-4-methyl-5-hydroxymethylimidazole, and the like.

Examples of the organophosphorus compounds include phosphines such as triphenylphosphine, tri-4-methylphenylphosphine, tri-3-methylphenylphosphine, tri-2-methylphenylphosphine, tri-4-methoxyphenylphosphine, tricyclohexylphosphine, tributylphosphine, trioctylphosphine and tri-2-cyanoethylphosphine; phosphoniums such as tetra-n-butylphosphonium bromide, tetra-n-butylphosphonium hydroxide, tetra-phenylphosphonium bromide, methyltriphenylphosphonium bromide, ethyltriphenylphosphonium bromide, n-butyltriphenylphosphonium bromide and tetraphenylphosphonium tetraphenylborate, etc.

Example of the sulfonium salts include bis[4-(diphenylsulfonio)phenyl]sulfide bishexafluorophosphate, bis[4-(diphenylsulfonio)phenyl]sulfide bishexafluoroantimonate, bis[4-(diphenylsulfonio)phenyl]sulfide bistetrafluoroborate, bis[4-(diphenylsulfonio)phenyl]sulfide tetrakis(pentafluorophenyl)borate, (2-ethoxy-1-methyl-2-oxoethyl)methyl-2-naphthalenyl-sulfonium hexafluorophosphate, (2-ethoxy-1-methyl-2-oxoethyl)methyl-2-naphthalenyl-sulfonium hexafluoroantimonate, (2-ethoxy-1-methyl-2-oxoethyl)methyl-2-naphthalenyl-sulfonium tetrafluoroborate, (2-ethoxy-1-methyl-2-oxoethyl)methyl-2-naphthalenyl-sulfonium tetrakis(pentafluorophenyl)borate, diphenyl-4-(phenylthio)phenylsulfonium hexafluorophosphate, diphenyl-4-(phenylthio)phenylsulfonium hexafluoroantimonate, diphenyl-4-(phenylthio)phenylsulfonium tetrafluoroborate, diphenyl-4-(phenylthio)phenylsulfonium tetrakis(pentafluorophenyl)borate, triphenylsulfonium hexafluorophosphate, triphenylsulfonium hexafluoroantimonate, triphenylsulfonium tetrafluoroborate, triphenylsulfonium tetrakis(pentafluorophenyl)borate, bis[4-(di(4-(2-hydroxyethoxy))phenylsulfonio)phenyl]sulfide bishexafluorophosphate, bis[4-(di(4-(2-hydroxyethoxy))phenylsulfonio)phenyl]sulfide bishexafluoroantimonate, bis[4-(di(4-(2-hydroxyethoxy))phenylsulfonio)phenyl]sulfide bistetrafluoroborate, bis[4-(di(4-(2-hydroxyethoxy))phenylsulfonio)phenyl]sulfide tetrakis(pentafluorophenyl)borate, etc.

When the electron-beam-curable resin, which can be used in the present invention, contains components other than olefin-based copolymer (A), i.e., curing agent (B) and curing catalyst (C) and the like, then the amount of the olefin-based copolymer (A) in the resin may be in the range of 50 to 99.9% by weight based on the resin.

The olefin-based copolymer (A) may be mixed with the other components, for example, by a method of melt-kneading olefin-based copolymer (A) at a temperature in the range of about 120 to 200° C. using a uniaxial or biaxial screw extruder, a Banbury mixer, a roll, various kneaders and the like and then mixing the other components therewith; a method of preliminarily dry-blending all the components and then melt-kneading the resulting mixture at a temperature in the range of about 90 to 180° C. using a uniaxial or biaxial screw extruder, a Banbury mixer, a roll, various kneaders and the like.

When the above-mentioned components (A) to (C) have a shape (such as a lump shape) other than a powder shape, the mixing of the components can be simplified by pulverizing the components using a pulverizer (such as a feather mill and an air mill) to prepare a powder thereof and then the powder is melt-blended. Such a pulverizing is preferred.

Further, if necessary, the above-mentioned electron-beam curable resin can be contain an additive such as a colorant, an inorganic filler, a processing stabilizer, an anti-weather agent, a thermal stabilizer, a photo stabilizer, a nucleating agent, a lubricant, a releasing agent, a flame retardant and an anti-static agent. When the inorganic filler is used, the amount of the inorganic filler is preferably used in the range of about 70 parts by weight or less, based on 100 parts by weight of the resin.

A film made of the above-mentioned electron-beam curable resin can be produced by a process such as:
(i) a process of extrusion-molding the electron-beam curable resin into a film shape with a T-die extruder and the like;
(ii) a process of extrusion-molding the resin into a film on a support, using a T-die extruder and the like;
(iii) a process of placing the film obtained in the above-mentioned process (i) onto a support;
(iv) a process of dissolving or dispersing the resin in an organic solvent and/or water to prepare an “adhesive solution” and coating an article with the solution to prepare the film on the article; and
(v) a process of preparing the adhesive solution, applying the solution onto a support, and drying the resultant to remove the organic solvent and/or water in the solution.

For electric and electronic parts, a film obtained by the above-mentioned process (iii) or (v) is preferably utilized.

Examples of the support which can be used in the present invention include a polyolefin-based film such as a film made of a 4-methyl-1-pentene copolymer, an acetyl cellulose film, a releasing paper on which a silicone-based releasing agent or a fluorine-based releasing agent was coated on a face contacting with the above-mentioned resin, a releasing polyethylene terephthalate (PET) film and the like.

When a film of the electron-beam curable resin is prepared using the above-mentioned adhesive solution (as in the process (iv) or (v)), the thickness of the film (which excludes the thicknesses of the article and the support) may be in the range of 3 μm or more from the viewpoint of adhesion property, and is preferably in the range of 3 to 100 μm, and is more preferably in the range of 3 to 50 μm.

The amount of the resin contained in the adhesive solution is preferable in the range of 10 to 150 parts by weight based on 100 parts by weight of the organic solvent and/or water which is/are contained together with the resin in the solution. In this case, a property of the adhesive solution as a coating solution tends to be superior.

Specific examples of the process using the adhesive solution for producing the film of the electron-beam curable resin, include a process of applying the solution onto an article or a support with a roll coater (such as a reverse roll coater, a gravure coater, a micro bar coater, a kiss coater, a Meyer bar coater and an air knife coater) a blade coater and the like, and then drying the solution as it is or drying the solution using a heating ventilation oven and the like, etc.

Among these, the process for producing the film using a roll coater is preferred, since the thickness of the film can be easily controlled from a thin film to a thick film.

Using the film of the electron-beam curable resin, an adhesive film can be obtained by a production method of the present invention, as illustrated above.

Using the adhesive film obtained in the present invention, a laminate can be produced by placing the film on an article, followed by heating.

Examples of the article for producing the laminate include articles made of metals such as gold, silver, copper, iron, tin, lead, aluminum and silicon; inorganic materials such as glass and ceramics; cellulose-based polymers such as a paper and a cloth; synthetic polymers such as a melamine-based resin, an acryl-urethane-based resin, a urethane-based resin, an acryl-based resin, a methacryl-based resin, a styrene-acrylonitrile-based copolymer, a polycarbonate-based resin, a phenol resin, an alkyd resin, an epoxy resin and silicone resin, and the like.

Two or more of components as above may be used (in mixing or compounding) to prepare the article.

The shape of the article is not specifically limited, and the article may be a film, a sheet, a plate, a fiber or the like.

If necessary, the article can be coated with a releasing agent, a plating, or a coating of a resin composition other than the resin used in the present invention. Also, the article can be subjected to a surface treatment such as surface modification by plasma or laser, surface oxidation and etching, if necessary.

The article may be laminated with the adhesive film obtained in the present invention by heating at a temperature in the range of 100 to 350° C., preferably at a temperature in the range of 120 to 300° C., and more preferably at a temperature in the range of 140 to 200° C. for 10 minutes to 3 hours. When the lamination is conducted at a temperature of 100° C. or higher, the period of time for obtaining the resulting laminate tends to be shortened, which is preferred. Further, when the lamination is conducted at a temperature of 350° C. or lower, thermal deterioration of the adhesive film tends to be suppressed, which is also preferred. The lamination may be conducted using a press machine equipped with a heating means under a pressure in the range of normal pressure to 6 MPa. Under such a condition, the adhesive film is cured so that a laminate superior in reliability can be obtained.

More specifically, a laminate in the present invention can be produced, as illustrated below. For example, when an adhesive film with a support is used, the laminate can be produced in a method in which the support is peeled off from the adhesive film, placing an article(s) on both faces or one side face of the adhesive film, and then heating the resultant; or in a method in which an article is placed on a face with no support of the adhesive film, the support is peeled off from the adhesive film, (if necessary, another article is placed on the face of a side from which the support has been peeled off), and then heating the resultant; or in a method in which the article is placed on a face with no support, the resultant is heated, and then the support is peeled off from the adhesive.

When two different articles are adhered with each other through the adhesive film in the present invention to produce a laminate, the materials of the articles may be the same as or different from each other.

The adhesive film obtained in the present invention can be preferably used in electric and electronic fields, and the laminate obtained by using the adhesive film is preferably used for electric and electronic parts such as an integrated circuit and a printed circuit board. For example, the laminate can be used to provide semiconductor parts.

The invention being thus described, it will be apparent that the same may be varied in many ways. Such variations are to be regarded as within the spirit and scope of the invention, and all such modifications as would be apparent to one skilled in the art are intended to be within the scope of the following claims.

The entire disclosure of the Japanese Patent Application No. 2003-412960 filed on Dec. 11, 2003, including specification, claims and summary, are incorporated herein by reference in their entirety.

### EXAMPLE

The present invention is described in more detail by following Examples, which should not be construed as a limitation upon the scope of the present invention.

### Example 1

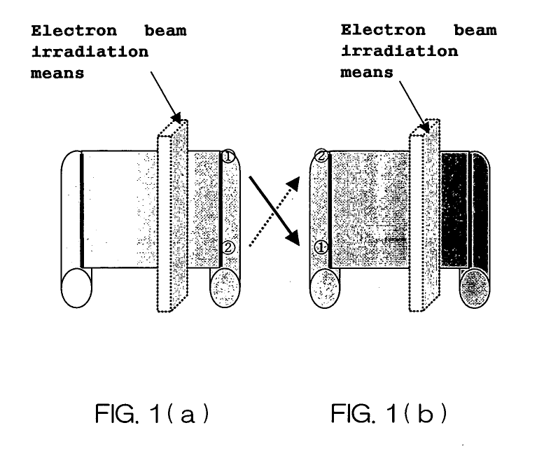

An adhesive film was produced using an electron-beam curable resin as shown below, by using a device (refer to FIG. 1(a) and FIG. 1(b)) which is equipped with a means of irradiating electron beam (the irradiation width of electron beam: 1650 mm), a means of continuously delivering a film to an irradiating position of electron beam, a means of continuously winding and collecting the film after the irradiation of electron beam and a means of continuously delivering again the film after winding and collecting to an irradiating position of electron beam.

Firstly, with respect to each of cases in which the setting values of electron beam irradiation were set at 90 kGy and 75 kGy by using the electron beam irradiating device, the quantity (dose) of the electron beam which actually reaches a film was measured as described below using a sample film.

Irradiation of electron beam to the sample film was carried out using the above-described device. After that, the sample film was cut off to provide specimens having the same area and the same shape, one by one from positions (1) to (17) which were partitioned at an interval of 100 mm along a width direction of the sample film. Each of the irradiation doses of electron beam which actually reached each of specimens at those positions was obtained, from the hue change (before and after the electron beam irradiation) of each of the specimens (using a previously prepared calibration line showing the relationship between irradiation dose of electron beam and hue change of the sample film due to the electron beam irradiation). The measurement result is shown in Table 1. In Example and Comparative Example, as well as in Table 1, the partitions corresponding to the positions (1) to (17), of the irradiation surface of the device is also referred as positions (1) to (17).

TABLE 1

| | | Irradiation dose of | Irradiation dose of |
|---|---|---|---|
| | | electron beam measured at | electron beam measured at |
| Position (mm) | | setting value of 90 kGy | setting value of 75 kGy |
| (1) | 0 | 81.5 | 63.4 |
| (2) | 100 | 94.7 | 73.6 |
| (3) | 200 | 93.3 | 72.6 |
| (4) | 300 | 90.3 | 70.2 |
| (5) | 400 | 93.9 | 73.0 |
| (6) | 500 | 85.5 | 66.5 |
| (7) | 600 | 85.4 | 66.4 |
| (8) | 700 | 88.8 | 69.1 |
| (9) | 800 | 84.2 | 65.5 |
| (10) | 900 | 86.7 | 67.4 |
| (11) | 1000 | 84.2 | 65.5 |
| (12) | 1100 | 80.7 | 62.8 |
| (13) | 1200 | 86.4 | 67.2 |
| (14) | 1300 | 96.2 | 74.8 |
| (15) | 1400 | 81.2 | 63.1 |
| (16) | 1500 | 97.7 | 76.0 |
| (17) | 1600 | 96.5 | 75.0 |

A resin composition (containing the ingredients shown in Table 2 below) was extruded onto a PET film as a support, to obtain an electron beam curable film with a thickness of 100 μm on the support.

TABLE 2

| | The amount |
|---|---|
| Component (A) | 100 parts |
| Component (B) | 5 parts |
| Phenol-based antioxidant | 0.1 parts |
| Phosphorus-based antioxidant | 0.1 parts |
| Sulfur-based antioxidant | 0.05 parts |

Component (A):
A ethylene-glycidyl methacrylate copolymer with the content of glycidyl methacrylate of 18.0% by weight and MFR of 350 g/10 min, manufactured by Sumitomo Chemical Co., Ltd.
   Component (B):
A phenol-modified product of liquid polybutadiene, PP-700-300, manufactured by Japan Petroleum Chemical Co., Ltd.
   Phenol-Based Antioxidant:
Irganox 1076, manufactured by Chiba Specialty Chemicals Co., Ltd.
   Phosphorus-Based Antioxidant:
Irgafos 168, manufactured by Chiba Specialty Chemicals Co., Ltd.
   Sulfur-Based Antioxidant:
Sumilizer TP-D, manufactured by Sumitomo Chemical Co., Ltd.

The above-obtained film was slit-processed in a width of 1050 mm, to prepare a roll-shaped wound film. Then, the irradiation of electron beam was carried out twice onto the film using the above-described electron-beam-irradiating device.

The first irradiation step (FIG. 1(a)) was carried out with a setting value of the electron-beam irradiation dose of 90 kGy, at an acceleration voltage of 225 kV, while setting and delivering the film so as to pass through positions (2) to (12) shown in Table 1. The electron-beam irradiated film was wound and collected with a roll. An average value, a difference between the maximum value and the minimum value, a dispersion degree and a standard deviation of the irradiation doses of electron beam irradiated on each partition equally partitioned into the same area and the same shape of the film were respectively 88.0 kGy, 14.0 kGy, 0.159 and 4.4, based on the actually measured value shown in Table 1.

The second irradiation step (FIG. 1(b)) was carried out on the same face as the face which was firstly irradiated above, while reversing the top and bottom of the film against the first irradiation, while setting and delivering the film to the same direction from the same side as the first irradiation so as to pass through positions (2) to (12). The setting value of the irradiation dose of electron beam was 75 kGy.

As described above, the top and bottom of the film were reversed to be set (namely, the film was set so that the film portion which was situated at position \mathring{1} in FIG. 1(a) after the first irradiation step came to position \mathring{1} in FIG. 1(b), and the film portion which was situated at position \mathring{2} in FIG. 1(a) after the first irradiation step came to position \mathring{2} in FIG. 1(b)), and then the film was delivered so as to pass through positions (2) to (12), while irradiating electron beam. Accordingly, the film portion which passed through position (2) in the first irradiation step passed position (12) in the second irradiation step; and the film portion which passed through position (3) in the first irradiation step passed position (11) in the second irradiation step. In such a manner, the film was delivered and electron beam was irradiated thereon.

Each of the accumulated irradiation doses after the second irradiation step (i.e., the sum of doses in the first and second irradiation steps in this Example) of electron beam which was irradiated on each of the partitions <a> to <k> (equally partitioned into the same area and the same shape) are shown in Table 3.

The average value, the difference between the maximum value and the minimum value, the dispersion degree and the standard deviation, of the accumulated irradiation doses of electron beam were 156.4 kGy, 7.6 kGy, 0.049 and 2.2, respectively.

TABLE 3

| | Sum of irradiation doses |
|---|---|
| | of electron beam |
| | (kGy) |
| <a> | 157.4 |
| <b> | 158.8 |
| <c> | 157.7 |
| <d> | 159.4 |
| <e> | 154.6 |
| <f> | 151.7 |
| <g> | 155.3 |
| <h> | 157.2 |
| <i> | 156.9 |
| <j> | 156.7 |
| <k> | 154.3 |

Samples having a diameter of 6 mmφ were punched out at an interval of about 50 mm along a width direction, from the film (adhesive film) which was obtained by the above-described two irradiation steps. The samples were pressed against an article under the condition of 180° C. and 1 MPa for 10 seconds. The percentage of a radius after the pressing to a radius before the pressing was used as an index for evaluating flowability of the samples. Since the radius after the pressing was increased in comparison with the radius before the pressing, the flowability was a value of 100% or larger. The value of the percentage indicates a flowability of the sample. For example, the larger value of the percentage corresponds to the higher flowability of the samples. Specific measured values are shown in Table 4. The average of the value representing the flowability was 114%, the difference between the maximum value and the minimum value was 2.9, the dispersion degree (i.e., a value obtained by dividing the difference between the maximum value and the minimum value by its average value) was 0.025 and the standard deviation was 0.8.

TABLE 4

| Position of | Flowability of |
|---|---|
| film (mm) | adhesive film (%) |
| 50 | 115.5 |
| 100 | 113.9 |
| 150 | 112.7 |
| 200 | 113.2 |
| 250 | 114.0 |
| 300 | 113.9 |
| 350 | 114.8 |
| 400 | 112.6 |
| 450 | 112.6 |
| 500 | 114.4 |
| 550 | 114.9 |
| 600 | 114.2 |
| 650 | 113.6 |
| 700 | 114.8 |
| 750 | 114.2 |
| 800 | 113.2 |
| 850 | 114.8 |
| 900 | 114.4 |
| 950 | 114.1 |
| 1000 | 113.4 |

### Comparative Example 1

A resin composition (containing the ingredients shown in Table 2 below) was extruded onto a PET film as a support, to obtain an electron beam curable film with a thickness of 100 μm on the support.

The obtained film was slit-processed in a width of 1050 mm, to prepare a roll-shaped film. The irradiation of electron beam was carried out twice onto the film, using the same electron-beam irradiating device as used in Example 1.

In the first irradiation step, the film was delivered to positions (4) to (14) shown in Table 1, and the irradiation of electron beam was carried out with a setting value of the electron-beam irradiation dose of 90 kGy, at an acceleration voltage of 225 kV. The electron beam irradiated film was wound and collected with a roll. An average value, a difference between the maximum value and the minimum value, a dispersion degree and a standard deviation of the irradiation doses of electron beam irradiated on each partition equally partitioned into the same area and the same shape of the film were respectively 87.5 kGy, 15.5 kGy, 0.177 and 4.3, based on the actually measured value shown in Table 1.

The second irradiation step was carried out on the same face as the face firstly irradiated above, while reversing the top and bottom of the film against the first irradiation, while setting and delivering the film to the same direction from the same side as the first irradiation so as to pass through positions (2) to (12). The setting value of the irradiation dose of the electron beam was 75 kGy.

Each of the accumulated irradiation doses after the second irradiation step (i.e., the sum of doses in the first and second irradiation steps in this Comparative Example) of electron beam which was irradiated on each partitions <a′> to <k′> (equally partitioned into the same area and the same shape) are shown in Table 5.

The average value, the difference between the maximum value and the minimum value, the dispersion degree and the standard deviation of the accumulated irradiation doses of electron beams were 155.9 kGy, 19.2 kGy, 0.123 and 5.7, respectively.

TABLE 5

| | Sum of irradiation |
|---|---|
| | dose of electron |
| | beam kGy |
| <a′> | 153.1 |
| <b′> | 159.4 |
| <c′> | 152.9 |
| <d′> | 150.8 |
| <e′> | 157.9 |
| <f′> | 150.5 |
| <g′> | 153.2 |
| <h′> | 157.2 |
| <i′> | 150.9 |
| <j′> | 159.0 |
| <k′> | 169.8 |

Samples having a diameter of 6 mmφ were punched out at an interval of about 50 mm along a width direction, from the film (adhesive film) which was obtained by the above-descrided two irradiation steps. The samples were pressed against an article under the conditions of 180° C. and 1 MPa for 10 seconds. The percentage (a value indicating flowability) of a radius after the pressing to a radius before the pressing is shown in Table 5. The average of the value indicating the flowability of the samples was 112.6%, the difference between the maximum value and the minimum value was 5.5, the dispersion degree (i.e., a value obtained by dividing the difference between the maximum value and the minimum value by its average value) was 0.049 and the standard deviation was 1.3.

TABLE 6

| Position of | Flowability of |
|---|---|
| film (mm) | adhesive film (%) |
| 50 | 111.7 |
| 100 | 111.6 |
| 150 | 111.8 |
| 200 | 114.1 |
| 250 | 112.7 |
| 300 | 112.9 |
| 350 | 112.7 |
| 400 | 112.9 |
| 450 | 112.6 |
| 500 | 111.6 |
| 550 | 112.7 |
| 600 | 112.4 |
| 650 | 112.7 |
| 700 | 113.1 |
| 750 | 111.7 |
| 800 | 115.7 |
| 850 | 114.9 |
| 900 | 113.4 |
| 950 | 110.2 |
| 1000 | 110.3 |

1. A process for producing an adhesive film comprising two or more steps of irradiating electron beam to a film made of an electron beam-curable resin, wherein
a standard deviation and a dispersion degree, of the accumulated irradiation doses of electron beam irradiated on partitions of the adhesive film equally partitioned into the same area and the same shape as one another after the final irradiation step
are respectively smaller than
a standard deviation and a dispersion degree, of the accumulated irradiation doses of electron beam irradiated on partitions of the resin film equally partitioned into the same area and the same shape as one another after the last irradiation step before the final irradiation step,
wherein the dispersion degree of the accumulated irradiation dose of electron beam is a value which is obtained by dividing the difference in the accumulated irradiation dose between its maximum dose and its minimum dose by its average does.

2. The production process according to claim 1, in which
a standard deviation and a dispersion degree, of the accumulated irradiation doses of electron beam irradiated on partitions of the adhesive film equally partitioned into the same area and the same shape as one another after the n^{th} irradiation step
are respectively smaller than
a standard deviation and a dispersion degree, of the accumulated irradiation doses of electron beam irradiated on partitions of the resin film equally partitioned into the same area and the same shape as one another after the (n−1)^{th} irradiation step,
wherein n represents an integer of 2 or more.

3. The production process according to claim 1, wherein the standard deviation and the dispersion degree of the accumulated irradiation doses of electron beam irradiated to partitions of the adhesive film after the final irradiation step are in the range of from 0 to 5 and in the range of 0 to 0.1, respectively

4. The production process according to anyone of claims 1 to 3, wherein the average value of the accumulated irradiation doses of electron beam irradiated to partitions of the adhesive film after the final irradiation step is in the range of from 10 kGy to 300 kGy.

5. The production process according to any one of claims 1 to 3, which is conducted using an apparatus comprising:
a means of irradiating electron beam to a film made of an electron beam-curable resin;
a means of delivering the film to the irradiating position of electron beam;
a means of winding and collecting the film after being irradiated with electron beam; and
an optional means of delivering again the film wound and collected, to the irradiating position of electron beam.

6. The production process according to any one of claims 1 to 3, wherein the electron beam curable resin comprises a copolymer containing, as the structural units thereof, the groups respectively derived from ethylene and a monomer represented by formula (1) below; 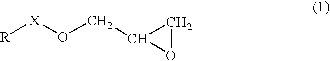
wherein R represents a hydrocarbon group having 2 to 18 carbon atoms which has at least one double bond, and a hydrogen atom in the hydrocarbon group is optionally substituted with a halogen atom, a hydroxy group or a carboxyl group; and X represents a single bond or a carbonyl group.

7. An adhesive film obtained by the production process according to any one of claims 1 to 3.

8. A laminate film comprising the adhesive film according to claim 7 and a support.

9. A laminate obtained by placing the adhesive film according to claim 7 on an article and thermally curing the film.

10. An adhesive film obtained by the production process according to claim 6.

11. A laminate film comprising the adhesive film according to claim 10 and a support.

12. A laminate obtained by placing the adhesive film according to claim 10 on an article and thermally curing the film.

13. A semiconductor part containing the laminate according to claim 9.

14. A semiconductor part containing the laminate according to claim 12.
